(19) United States
(12) Patent Application Publication
(10) Pub. No.: US 2023/0072030 A1
(43) Pub. Date: Mar. 9, 2023

(54) PATH PLANNING WITH DIRECTION OF TRAVEL AT START AND END POINTS

(71) Applicants: Mohammad Shafikul Huq, HAMTRAMCK, MI (US); Shakura Quabili, HAMTRAMCK, MI (US)

(72) Inventors: Mohammad S. Huq, HAMTRAMCK, MI (US); Shakura Quabili, HAMTRAMCK, MI (US)

(73) Assignees: Mohammad Shafikul Huq, HAMTRAMCK, MI (US); Shakura Quabili, HAMTRAMCK, MI (US)

(21) Appl. No.: 17/880,654

(22) Filed: Aug. 4, 2022

Related U.S. Application Data
(60) Provisional application No. 63/241,062, filed on Sep. 6, 2021.

(51) Int. Cl. G01C 21/34

(52) U.S. Cl. CPC G01C 21/34

(57) ABSTRACT

A method is defined for a path to be designed from a sequence of way points called departing way point P_{d}, way point X₁, way point X₂, . . . , way point X_{N}, and merging way point Pₘ, where directions of travel of a vehicle at departing and merging points are given at angles Θ_{d} and Θₘ or other forms of direction with respect to two given path segments, L_{d} and Lₘ, passing through the departing and merging way points successively. In order to plan a path, we pick two points, P₋₁ and P₊₁ on both sides of the point P_{d} located on the path segment L_{d}. We draw a line P₋₁P₊₁ passing through points P₋₁ and P₊₁. We pick two points, P₋₂ and P₊₂ on both sides of the point Pₘ located on the path segment Lₘ. We draw another line P₋₂P₊₂ passing through points P₋₂ and P₊₂. We draw two lines passing through P_{d} and Pₘ such that they make angles Θ_{d} and Θₘ with respect to the lines P₋₁P₊₁ and P₋₂P₊₂ successively. Then we pick point P₁ and point P₂ on these two lines. Now, we fit a B-Spline or B-Spline like curve to the sequence of points departing way point P_{d}, way point P₁, way point X₁, way point X₂, . . . , way point X_{N}, way point P₂, and merging way point Pₘ. The B-Spline curve is the path planned for the vehicle to travel where the vehicle not only passes through the points P_{d} and Pₘ, but also maintains a travel direction at angles Θ_{d} and Θₘ with respect to given path segments, L_{d} and Lₘ.

### CROSS REFERENCE TO RELATED APPLICATION

This application is a continuation application of U.S. Provisional Patent Application No. 63/241,062, filed Sep. 6, 2021 with conformation number 7693, the contents of which are incorporated herein by reference almost in their entirety, with claims unchanged.

### FIELD OF THE INVENTION

The present invention relates to B-Spline base path planning that can be used in Advanced Driver Assist Systems (ADAS) or Automated Driving (AD) features. Given a start (departing) and end (merging) points and one or more points in between them, a B-Spline curve can be fit to all the points. The B-Spline curve is smooth and makes sure that it travels through the departing and merging points. For path planning however, it is necessary to ensure that the path not only passes through the departing and merging points, but also, the path maintains given directions at both the points, such as the directions pointed out by the road segments at both points. This kind of path planning is useful for, for instance, automated lane change or obstacle avoidance features of a vehicle.

### BACKGROUND

Path planning is an important subject in Advanced Driver Assist Systems (ADAS) or Automated Driving (AD) since it is at the center of a number of important vehicle features: lane change, lane keeping assist, and obstacle avoidance.

Path planning for the features mentioned above is done, first, by picking some way points along the path and then fitting a curve such as B-Spline on these points. B-Spline curve makes sure that the path is smooth and also passes through the departing and merging points.

For path planning of a vehicle however, it is also necessary to define what the directions of travel of the vehicle should be at the departing and merging points. The directions could be given by lines drawn at those two points or by the road segments at those two points. The invention presented here proposes a path that goes through the departing and merging points and maintains directions given at departing and merging points.

There is a related patent to the proposed invention, which is U.S. Ser. No. 11/235,804B2. The main difference of our proposed method from the one proposed in U.S. Ser. No. 11/235,804B2 is that the authors modeled a path by determining tangents at starting and end points of the path. In our proposed method, the path is entirely modeled by choosing points only, i.e., our proposed method is able to maintain direction at the beginning and end of the path even without using tangents.

### BRIEF SUMMARY OF THE INVENTION

A method is defined for a path to be designed from a sequence of way points called departing way point P_{d}, way point X₁, way point X₂, . . . , way point X_{N}, and merging way point Pₘ, where directions of travel of a vehicle at departing and merging points are given at angles Θ_{d} and Θₘ or other forms of direction with respect to two given path segments, L_{d} and Lₘ, passing through the departing and merging way points successively. In order to plan a path, we pick two points, P₋₁ and P₊₁ on both sides of the point P_{d} located on the path segment L_{d}. We draw a line P₋₁P₊₁ passing through points P₋₁ and P₊₁. We pick two points, P₋₂ and P₊₂ on both sides of the point Pₘ located on the path segment Lₘ. We draw another line P₋₂ P₊₂ passing through points P₋₂ and P₊₂. We draw two lines passing through P_{d} and Pₘ such that they make angles Θ_{d} and Θₘ with respect to the lines P₋₁P₊₁ and P₋₂ P₊₂ successively. Then we pick point P₁ and point P₂ on these two lines. Now, we fit a B-Spline or B-Spline like curve to the sequence of points departing way point P_{d}, way point P₁, way point X₁, way point X₂, . . . , way point X_{N}, way point P₂, and merging way point Pₘ. The B-Spline curve is the path planned for the vehicle to travel where the vehicle not only passes through the points P_{d} and Pₘ, but also maintains a travel direction at angles Θ_{d} and Θₘ with respect to given path segments, L_{d} and Lₘ.

### BRIEF DESCRIPTION OF THE DRAWINGS

A method of the present invention is illustrated in drawings, in which:

FIG. 1—FIG. 1 describes the precondition and given information for the path to be planned.

FIG. 2—FIG. 2 presents the method to be followed to obtain the path.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

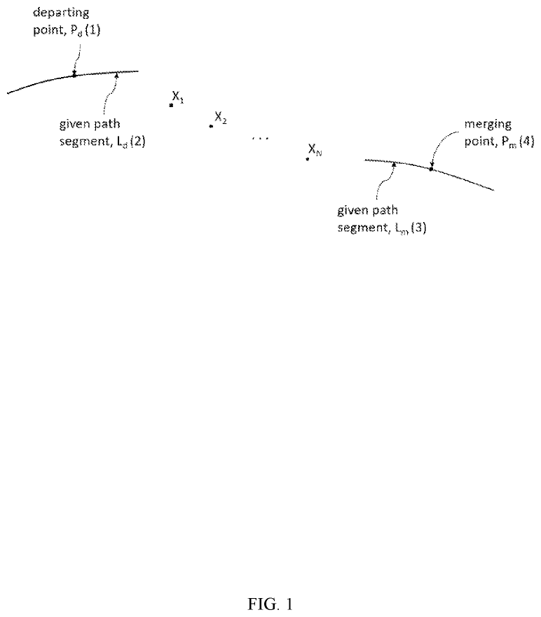

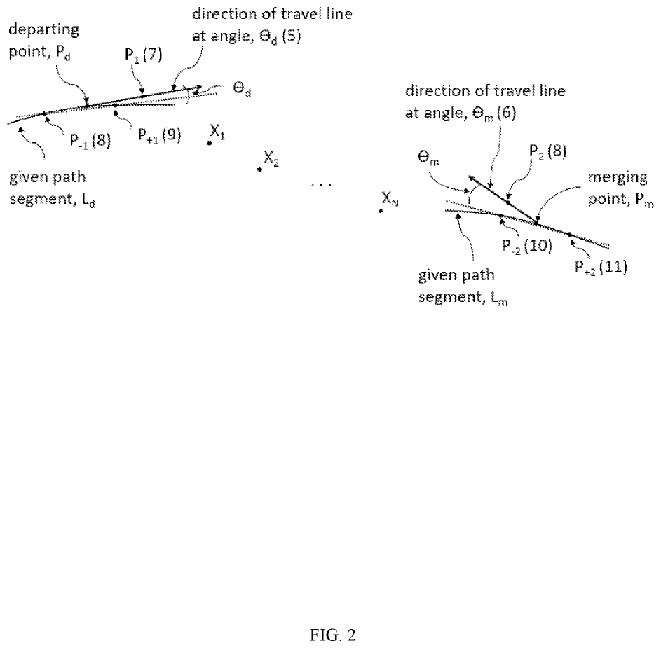

The present invention, a method for path planning given a number of way points and the direction of travel of a vehicle at departing and merging way points will now be described by referencing the appended figures, FIG. 1 and FIG. 2.

In the presented invention, a method is defined for a path to be designed from a sequence of way points called departing way point P_{d}, way point X₁, way point X₂, . . . , way point X_{N}, and merging way point Pₘ, where directions of travel of a vehicle at departing and merging points are given at angles Θ_{d} and Θₘ or other forms of direction with respect to two given path segments, L_{d} 2 and Lₘ 3, passing through the departing and merging way points successively. In order to plan a path, we pick two points, P₋₁ 8 and P₊₁ 9 on both sides of the point P_{d} located on the path segment L_{d}. We draw a line P₋₁P₊₁ passing through points P₋₁ and P₊₁. We pick two points, P₋₂ 10 and P₊₂ 11 on both sides of the point Pₘ located on the path segment Lₘ. We draw another line P₋₂ P₊₂ passing through points P₋₂ and P₊₂. We draw two lines 5, 6 passing through P_{d} and Pₘ such that they make angles Θ_{d} and Θₘ with respect to the lines P₋₁P₊₁ and P₋₂ P₊₂ successively. Then we pick point P₁ 7 on line 5 and point P₂ on line 6. Now, we fit a B-Spline or B-Spline like curve to the sequence of points departing way point P_{d}, way point P₁, way point X₁, way point X₂, . . . , way point X_{N}, way point P₂, and merging way point Pₘ. The B-Spline curve is the path planned for the vehicle to travel where the vehicle not only passes through the points P_{d} and Pₘ, but also maintains a travel direction at angles Θ_{d} and Θₘ with respect to given path segments, L_{d} and Lₘ. The curve is the path for the vehicle where the path not only goes through the departing and merging way points, but also the path maintains directions at those two points the vehicle should follow.

1. A method is defined for a path to be designed from a sequence of way points called departing way point P_{d}, way point X₁, way point X₂, . . . , way point X_{N}, and merging way point Pₘ, where directions of travel of a vehicle at departing and merging way points are given at angles Θ_{d} and Θₘ or other forms of direction with respect to two path segments, L_{d} and Lₘ successively, passing through the departing and merging way points, the method comprising steps:
picking two points, P₋₁ and P₊₁ on both sides of the point P_{d} located on the path segment L_{d}. We draw a line P₋₁P₊₁ passing through points P₋₁ and P₊₁;
picking two points, P₋₂ and P₊₂ on both sides of the point Pₘ located on the path segment Lₘ. We draw another line P₋₂ P₊₂ passing through points P₋₂ and P₊₂;
drawing two lines passing through P_{d} and Pₘ such that they make angles Θ_{d} and Θₘ with respect to the lines P₋₁P₊₁ and P₋₂ P₊₂ successively. Point P₁ and point P₂ are picked on these two lines; and
determining a new path using B-Spline or other B-Spline like curve fitting approach on the sequence of points departing way point P_{d}, way point P₁, way point X₁, way point X₂, . . . , way point X_{N}, way point P₂, and merging way point Pₘ.

2. A method as defined in claim 1, wherein a tangent can be drawn on path segment L_{d} at its point P_{d} and the tangent line is used instead of using the line P₋₁P₊₁ and a tangent can be drawn on path segment Lₘ at its point Pₘ and the tangent line is used instead of using the line P₋₂ P₊₂.

3. A method as defined in claims 1 and 2, wherein the same path designed for the vehicle can also be used in path or curve design for other applications.
